(19) United States
(12) Patent Application Publication
(10) Pub. No.: US 2026/0138389 A1
(43) Pub. Date: May 21, 2026

(54) PRE-CUT PAPER SHEETS AND KIT

(71) Applicant: Foldfactory.com, Corp. DBA Freshcut Crafts, Phoenix, MD (US)

(72) Inventor: Patricia Witkowski, Phoenix, MD (US)

(21) Appl. No.: 19/233,836

(22) Filed: Jun. 10, 2025

Related U.S. Application Data
(60) Provisional application No. 63/658,348, filed on Jun. 10, 2024.

(51) Int. Cl. B42D 15/00; B42D 15/04

(52) U.S. Cl. CPC B42D 15/0073; B42D 15/042

(57) ABSTRACT

A pre-cut paper sheet and kit are disclosed for use in crafting, educational, and manipulative applications without requiring specialized cutting tools. Each paper sheet comprises a plurality of predetermined geometric or organic shapes pre-cut into a sheet of paper and retained therein by small, frangible paper tabs configured to allow smooth manual removal of the shapes. One or more of the pre-cut shapes may further include perforations configured to divide an individual shape into two or more predetermined portions, facilitating instruction and demonstration of mathematical, geometric, and spatial concepts. The kit may include multiple sheets of differing colors and shape arrangements, along with optional paper-based accessories, instructional materials, and packaging. The pre-cut paper sheets and kit provide a portable, scalable alternative to traditional punch-art tools while enabling creative, educational, and hands-on learning experiences.

### CROSS-REFERENCE TO RELATED APPLICATIONS

The present application claims the benefit of Provisional Application No. 63/658,348 filed Jun. 10, 2024.

### TECHNICAL FIELD

This invention relates generally to pre-cut paper sheets and kit, and more specifically, to portable, pre-cut, punch-out, paper sheets and kit.

### BACKGROUND

Punch art is a paper craft industry term for using metal punches to punch geometric or organic shapes out of colored card stock paper and combining those shapes to create characters or recognizable decorative objects. This traditional approach to making punch art is problematic because it requires that the crafter own or have access to all of the necessary metal punches in all of the right shapes and sizes to make their desired characters or decorative objects. It also requires the crafter to have a requisite level of skill and strength to use the metal punches to make the right shapes.

Furthermore, traditional punch art has generally been used in the craft industry to create artistic and/or decorative objects. It generally has not heretofore been configured to be utilized in the educational and/or learning field in the form of manipulatives and/or aids. The applicant has determined that existing approaches in these regards leave room for considerable improvement.

### BRIEF DESCRIPTION OF THE DRAWINGS

The above needs are at least partially met through provision of the pre-cut paper kit described in the following detailed description, particularly when studied in conjunction with the drawings, wherein:

FIG. 1 comprises a view of a paper craft kit configured in accordance with various embodiments of the invention;

FIG. 2 comprises a view of sheets of paper of a paper craft kit configured in accordance with various embodiments of the invention;

FIG. 3 comprises a view of accessories of a paper craft kit configured in accordance with various embodiments of the invention;

FIG. 4 comprises a view of another accessory of a paper craft kit configured in accordance with various embodiments of the invention;

FIG. 5 comprises a view of another accessory of a paper craft kit configured in accordance with various embodiments of the invention;

FIG. 6 comprises a view of another accessory of a paper craft kit configured in accordance with various embodiments of the invention;

FIG. 7 comprises another view of the accessory of FIG. 6; and

FIG. 8 comprises view of an instruction sheet of a paper craft kit configured in accordance with various embodiments of the invention;

FIG. 9 comprises another view of the instruction sheet of FIG. 8;

FIG. 10 comprises a view of packaging of a paper craft kit configured in accordance with various embodiments of the invention;

FIG. 11 comprises another view of the packaging of FIG. 10;

FIG. 12 comprises a view of additional packages of paper craft kits configured in accordance with various additional embodiments of the invention; and

FIG. 13 comprises a front view of a pre-cut paper sheet in accordance with various embodiments of the invention;

FIG. 14 comprises a rear view of the pre-cut paper sheet of FIG. 13;

FIG. 15 comprises a front view of a pre-cut paper sheet in accordance with various embodiments of the invention;

FIG. 16 comprises a rear view of the pre-cut paper sheet of FIG. 15;

FIG. 17 comprises a front view of a pre-cut paper sheet in accordance with various embodiments of the invention;

FIG. 18 comprises a rear view of the pre-cut paper sheet of FIG. 17;

FIGS. 19-21 comprise views of die patterns for making pre-cut paper sheets in accordance with various embodiments of the invention;

FIG. 22 comprises a view of a pre-cut paper kit in accordance with various embodiments of the invention;

FIG. 23 comprises a view of another pre-cut paper kit in accordance with various embodiments of the invention;

FIG. 24 comprises a view of a pre-cut paper sheet in accordance with various embodiments of the invention;

FIG. 25 comprises a view of another pre-cut paper sheet in accordance with various embodiments of the invention; and

FIG. 26 comprises a view of a die pattern for making pre-cut paper sheets in accordance with various embodiments of the invention.

Common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments comprise a pre-cut paper kit which provides the same experience of creating punch art, without the need for any specialized cutting tools. These teachings are highly flexible and scalable in practice and can serve to leverage a wide variety of existing paper craft tools and/or methods.

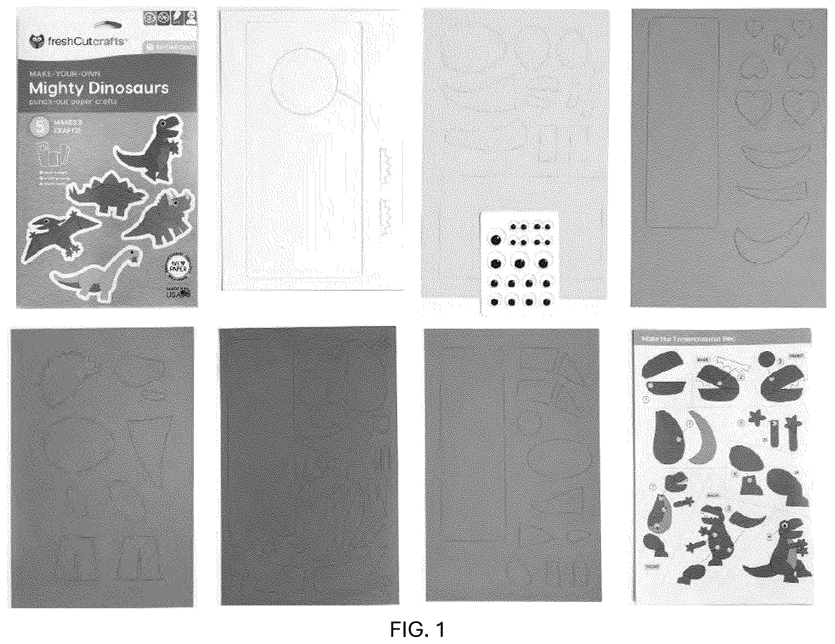

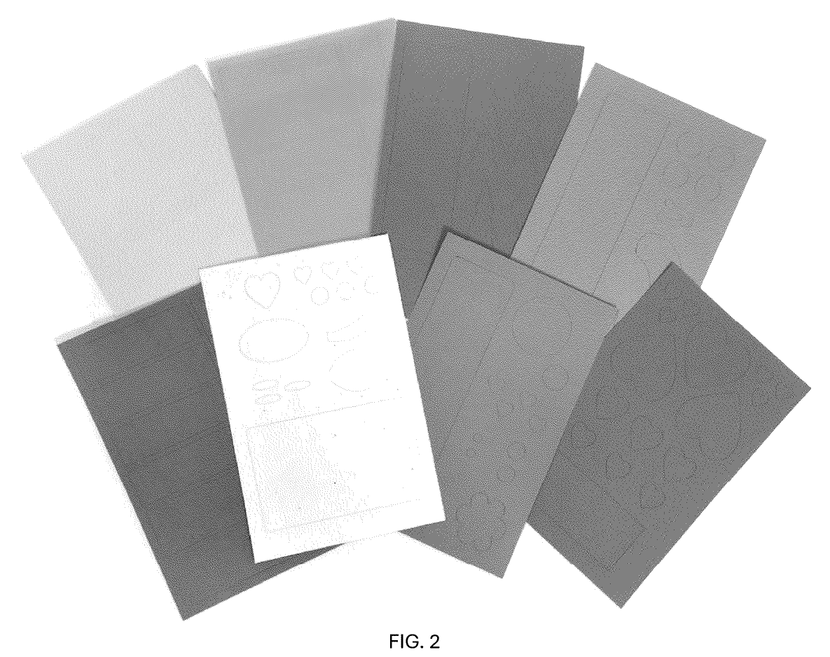

With reference to FIGS. 1 and 2, in accordance with one aspect of the invention, the paper craft kit includes one or more sheets of pre-cut paper. The sheets are preferably bright, saturated, blank colored card stock. Preferably, the paper is of a suitable weight commonly used in the paper craft industry. Also preferably, the paper weight permits a consistent feel, finish and form, supports portability and consistency of manufacturing, and keeps bulkiness of the package and the finished craft to a minimum. In one preferred form, the paper is about 65 lb. to about 80 lb. or equivalent in weight, uncoated cover.

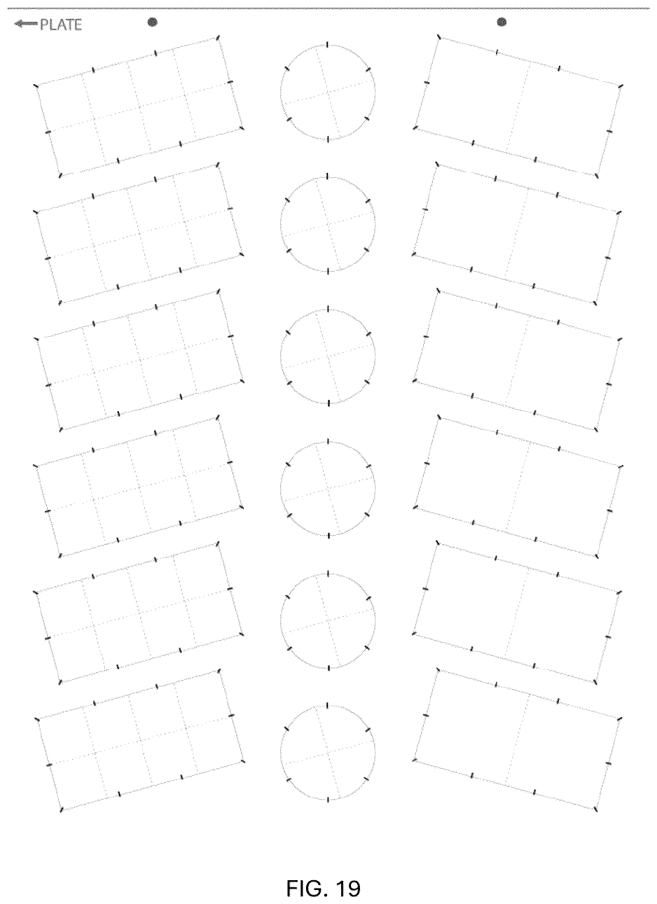

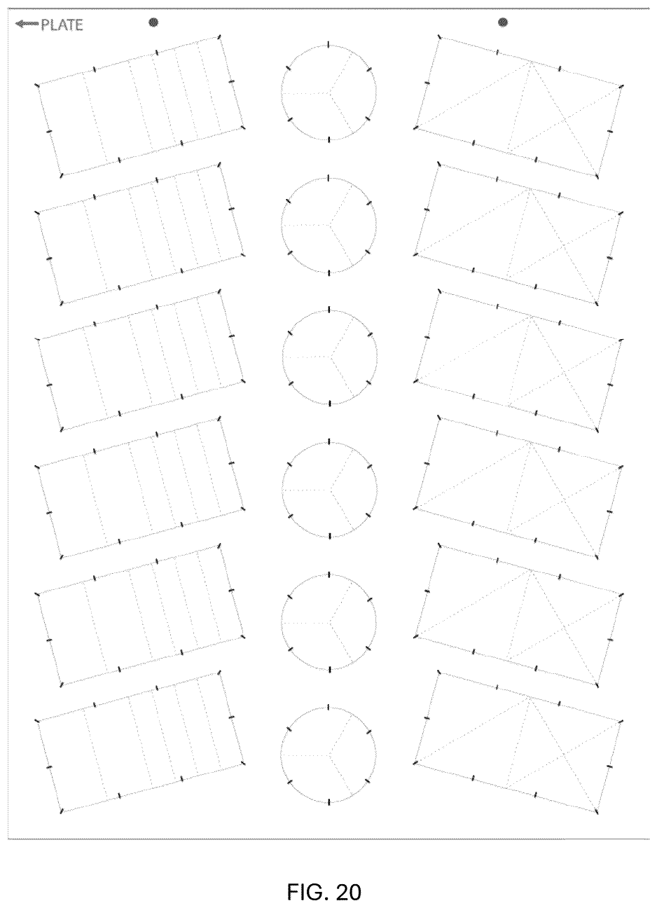

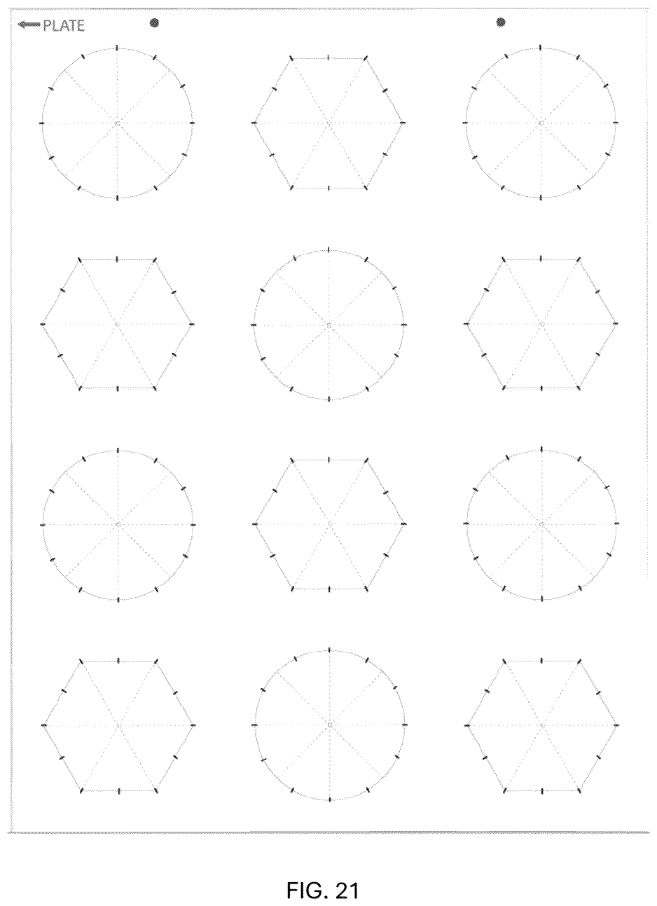

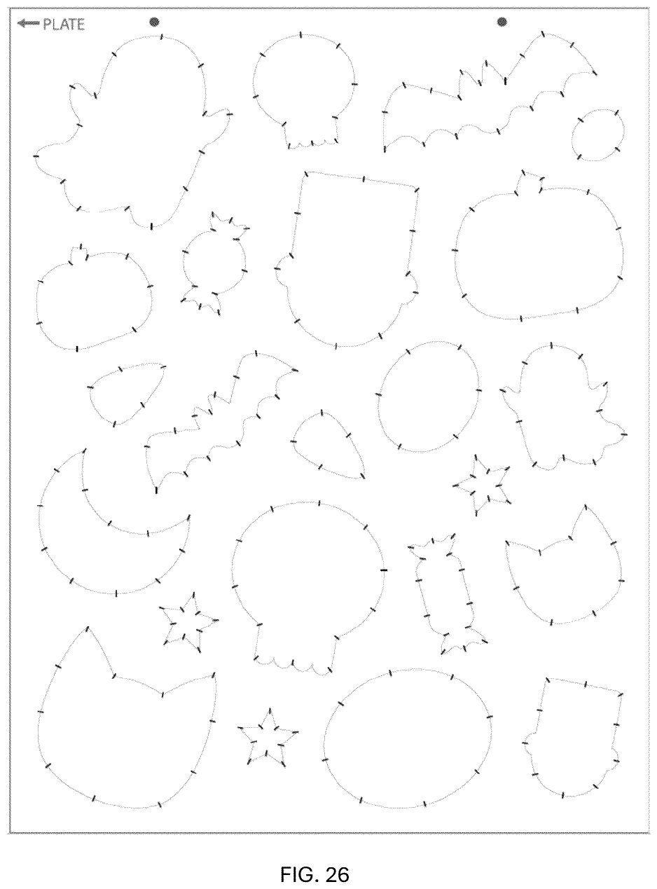

The kit may include one or more of a variety of different colored sheets. Each of the sheets may have one or more predetermined shapes pre-cut therein. The shapes may be cut into sheets by any known cutting technology, including but not limited to, laser cutting, metal plates and rotary die-cutting, automated knife cutting, and digital flatbed cutting. The shapes themselves may include one or more geometric or organic shapes. In one embodiment, the shapes may be cut into sheets using a variety of die patterns as shown, for example, in FIGS. 19-21 and 26. The die patterns are preferably configured to form the shapes, accessories, tabs, and perforations detailed further below.

In accordance with another aspect, the pre-cut shapes are held securely in place in the sheets with one or more small “tabs” of paper that form a connection between the shape and the sheet that holds it. The tabs are preferably small, and allow the shape to be manually removed (i.e., punched out) smoothly with barely a trace of the tabs remaining attached to the shapes. In one preferred form, the tabs are up to about 1.5 pt. in width.

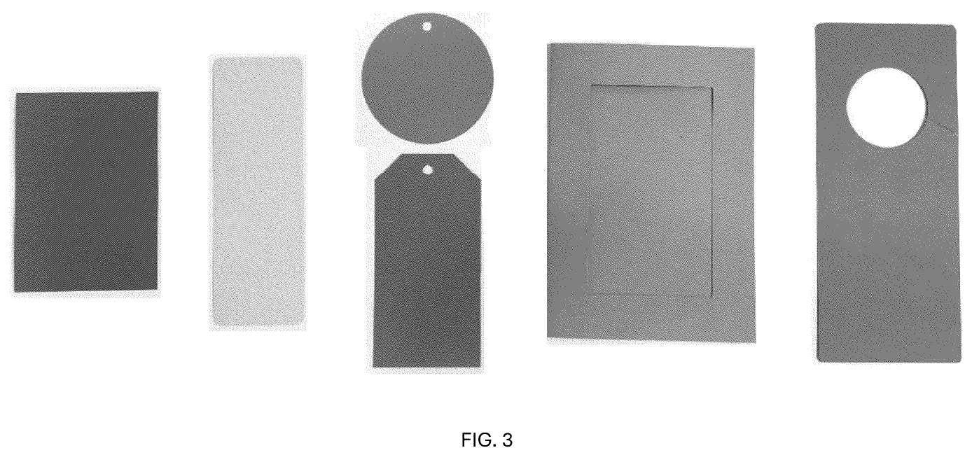

With reference to FIGS. 3-7, the paper craft kit may also include one or more paper-based accessories or support items such as scored greeting cards, envelopes, bookmarks, ornaments, tabs, door hangers, tags, flat cards of various shapes, trading cards, Valentine cards, treat-toppers, and the like.

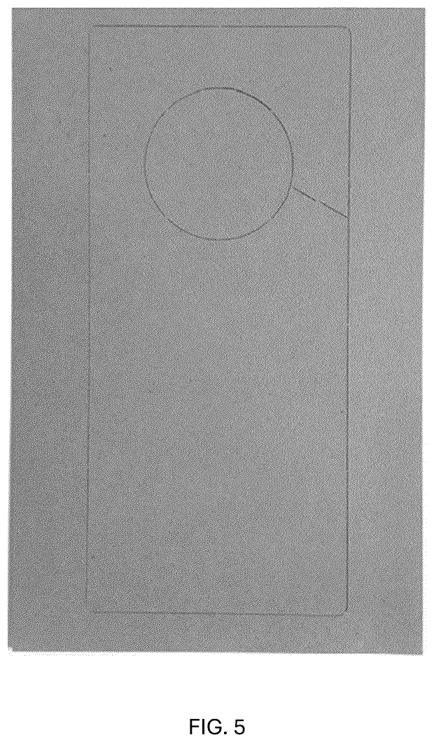

The accessories may include, for example, one or more pieces of pre-cut or scored card stock. The pieces may be formed of the same colored card stock noted above and pre-cut or scored into a variety of shapes such as folding cards, bookmarks, ornaments, tabs, door hangers, tags, flat cards of various shapes, trading cards, Valentine cards, treat-toppers, and the like. As shown in FIG. 5, these accessory items may also be held in the sheets with a series of tabs.

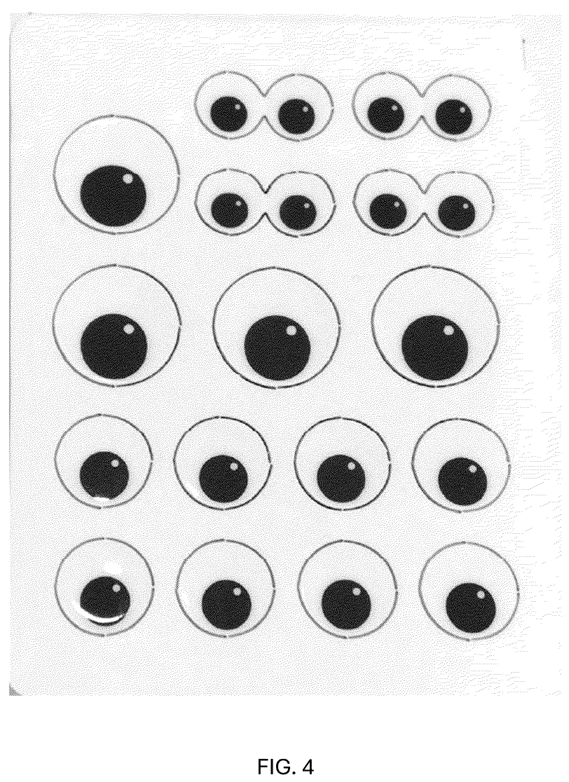

In another aspect, as illustrated in FIG. 4, the accessories may include one or more pieces of pre-cut paper eyes. The paper eyes may have an appearance that mimics traditional plastic googly eyes or jiggly eyes. Googly eyes are small plastic craft supplies used to imitate eyeballs. They traditionally are composed of a white plastic or card backing covered by a clear, hard-plastic shell, encapsulating a black plastic disk. The combination of a black circle over a white disk mimics the appearance of the sclera and pupil of the eye to humorous effect.

In one form, the pre-cut paper eyes of the present invention may comprise a white background with a black circle printed thereon. A clear gloss raised texture may be applied thereto to mimic the appearance of the clear plastic shell of a traditional googly eye. In one form, the clear gloss coating may be about 3 to about 6 mil (about 0.003 to about 0.006 inch/about 0.076 to about 0.152 mm) in height, raised crystal clear press coating, which may be applied to the paper using known means, including but not limited to, a raised digital enhancement, raised UV coating, specialty screen print ink, thermography, lamination, embossing, or other existing raised print techniques.

The pre-cut-paper eyes may comprise a single circle representing a single eye or a pair of joined circles representing a pair of eyes.

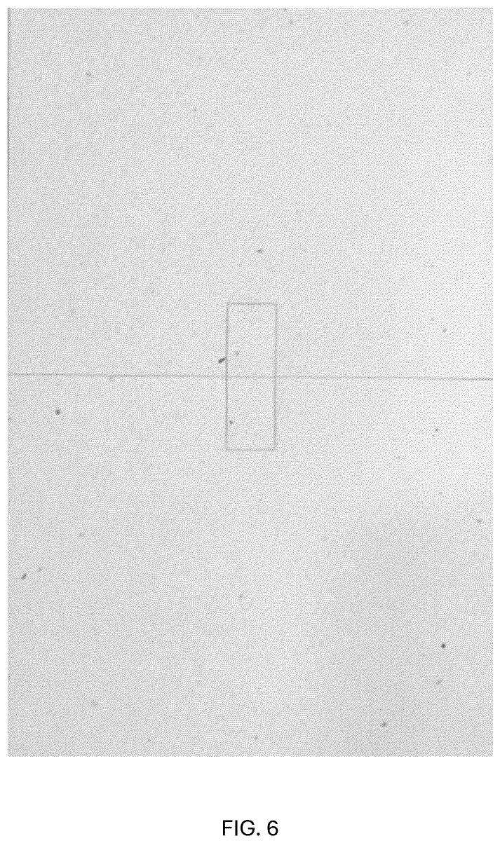

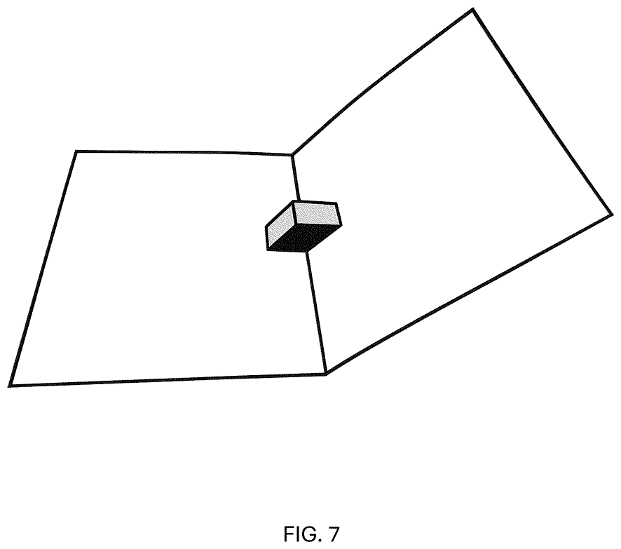

In another aspect, as illustrated in FIGS. 6 and 7, the accessories may comprise a pop-up card insert. In one form, the pop-up card insert comprises a piece of paper with a first fold line generally bisecting the paper horizontally. A rectangle pop-up tab is disposed generally perpendicular to the fold line. The pop-up tab has a second fold line that bisects the pop-up tab horizontally. The second fold line is arranged opposite to the first fold line. Hence, as shown in FIG. 7, when the pop-up card is opened, it causes the pop-up tab to pop-up, or space apart from the card.

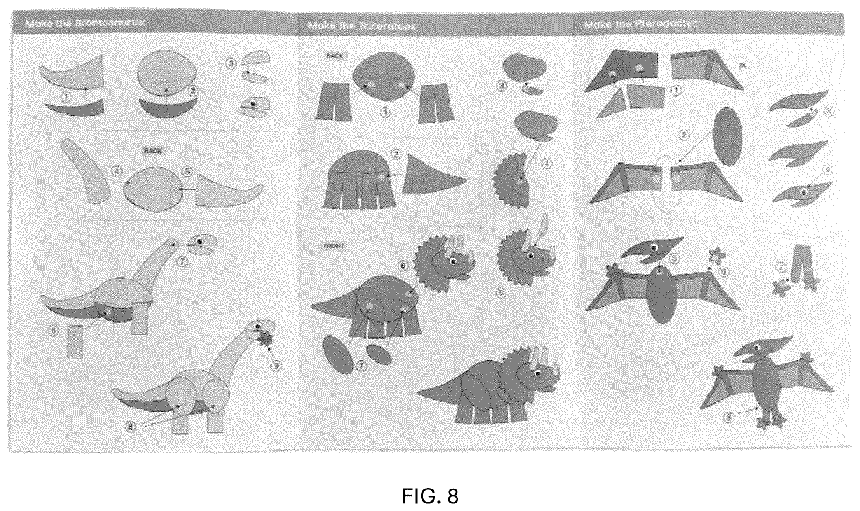

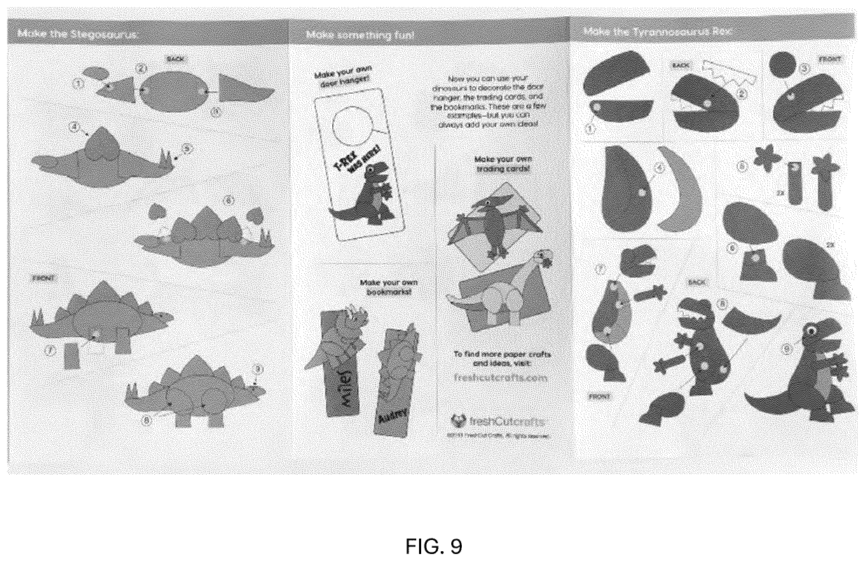

As illustrated in FIGS. 8 and 9, each paper craft kit may include an instruction sheet. The instruction sheet may include step-by-step written and/or pictorial instructions for preparing the craft project included within the kit.

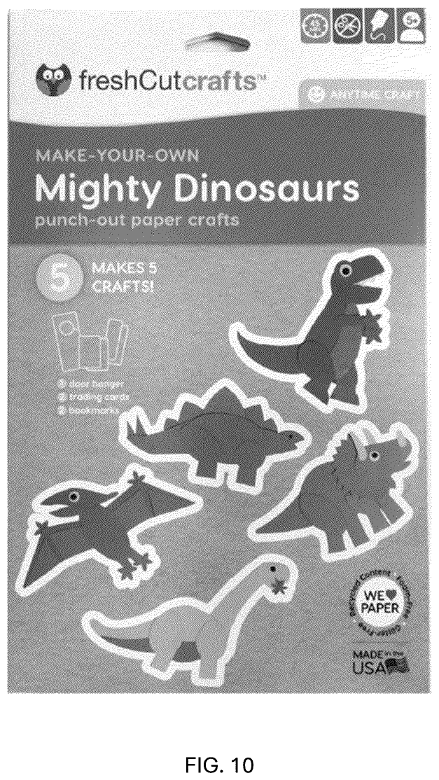

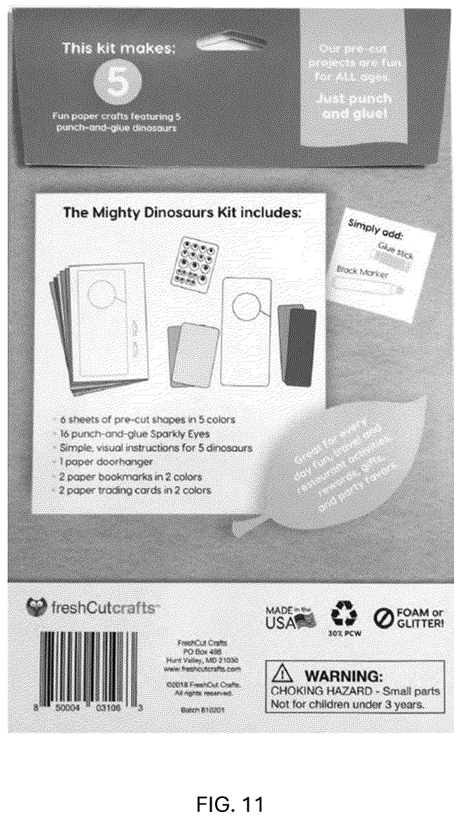

In accordance with another aspect, and illustrated in FIGS. 10 and 11, each kit is preferably contained in packaging comprising a compact paper or clear plastic envelope, sleeve, pouch, or the like. In one preferred form, the packaging may include pictures or text describing the contents of the kit, the kit's theme, and/or the type of project contained within the kit.

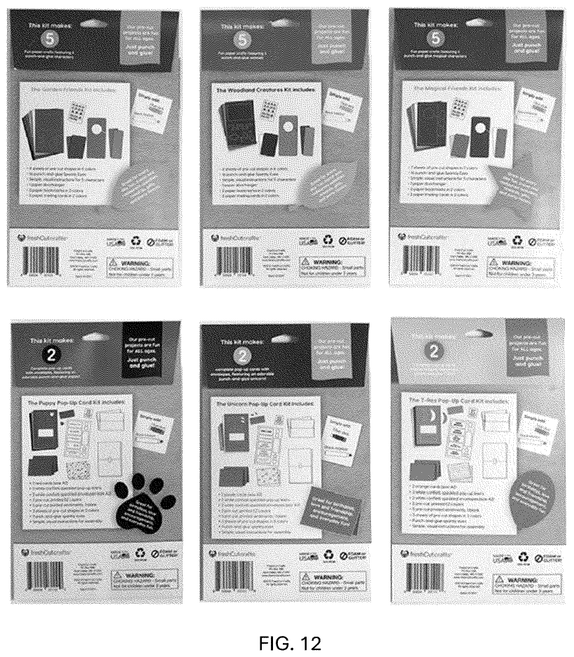

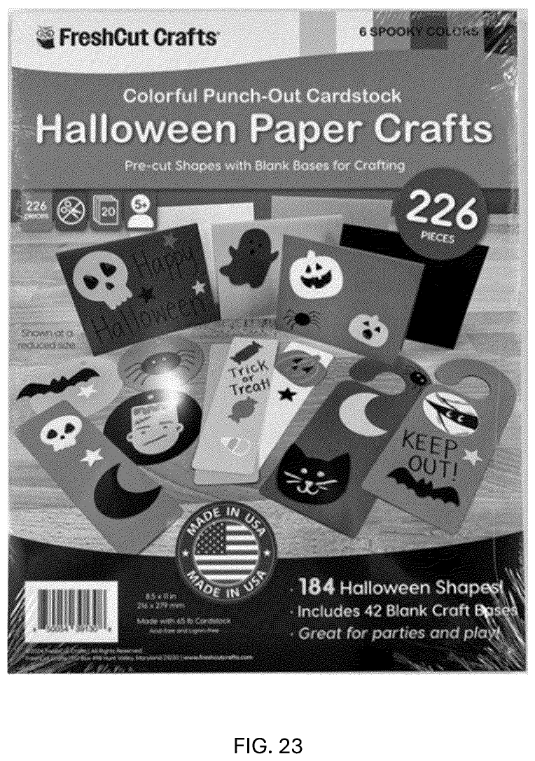

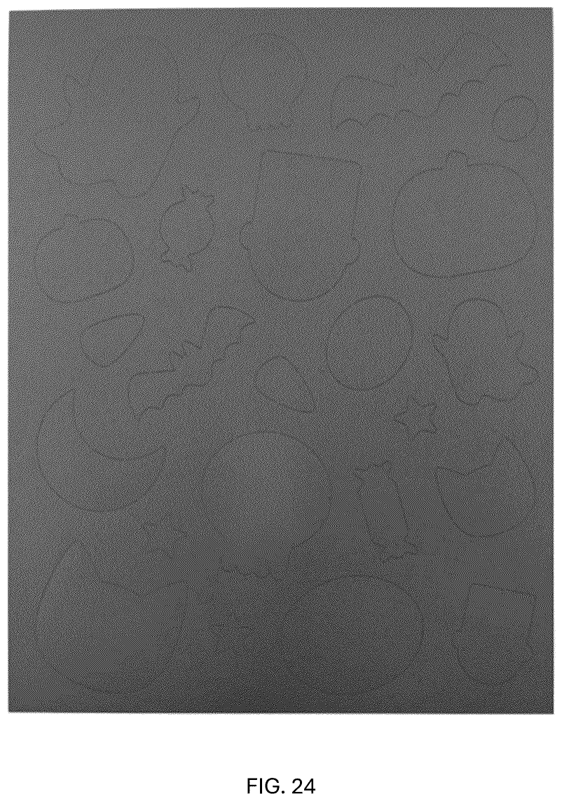

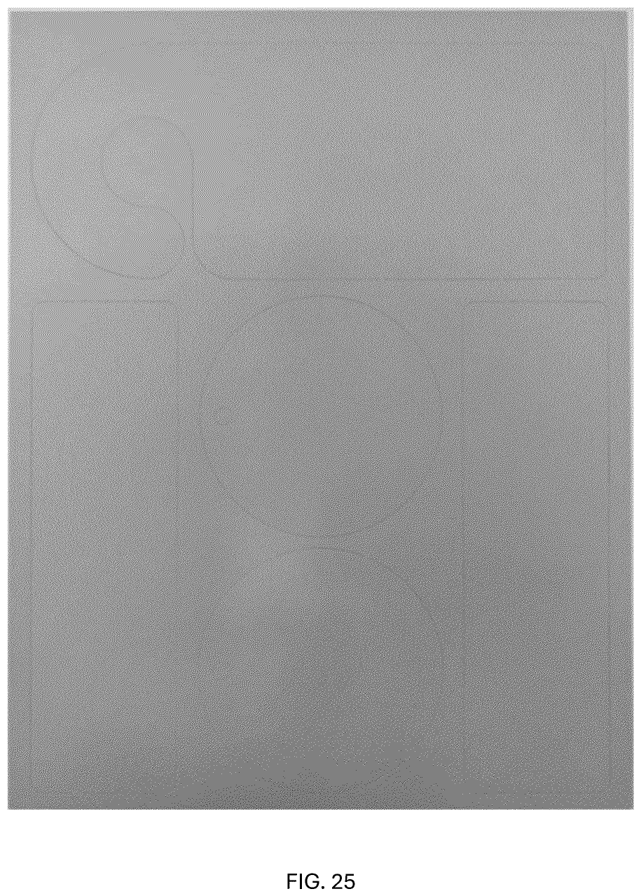

Each kit may feature a theme and a related project—for example, a Winter Holiday theme with a paper ornament project, or a Butterfly theme with a butterfly bookmark project. As will be readily understood by one of ordinary skill in the art, the kit may include any variety of different themes and/or projects. Examples of some possible themes and projects may include, without limitation, basic shapes (for example, hearts, stars, diamonds, geometric shapes), letters, numbers, math shapes, art shapes, seasonal shapes (for example, spring, summer, fall, winter), holiday shapes, religious shapes, organic shapes, musical shapes, fish, animals, snowflakes, crowns, angels, flowers, trees, leaves, stars, maps, states, flags, hands, and the like. Examples of some possible themes and projects contemplated herein are shown, for example, in FIGS. 10-12, 22, and 23.

Finally, the paper craft kit may include any number of additional items that may be useful for preparing the craft project. Additional items may include, but not be limited to glue, glue dots, a glue stick, paste, or other forms of adhesive. One or more writing utensils such as crayons, markers, or colored pencils could also be included in the kit.

Those skilled in the art will recognize that the above described embodiments may be combined in different arrangements to provide a wide variety of paper craft kits.

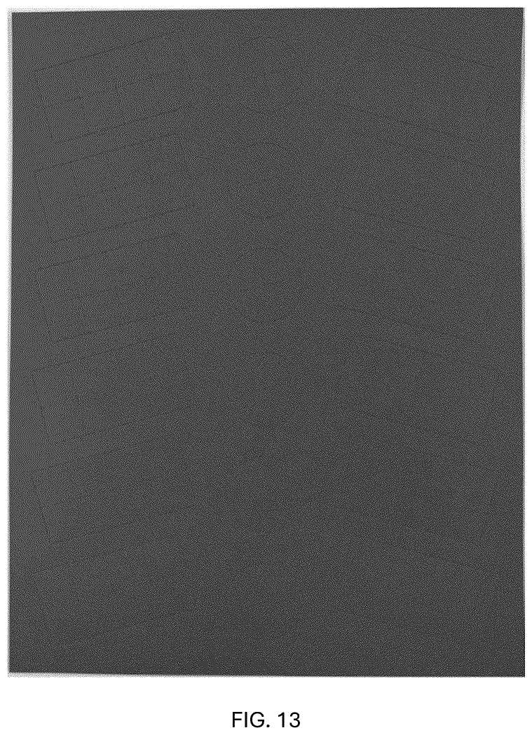

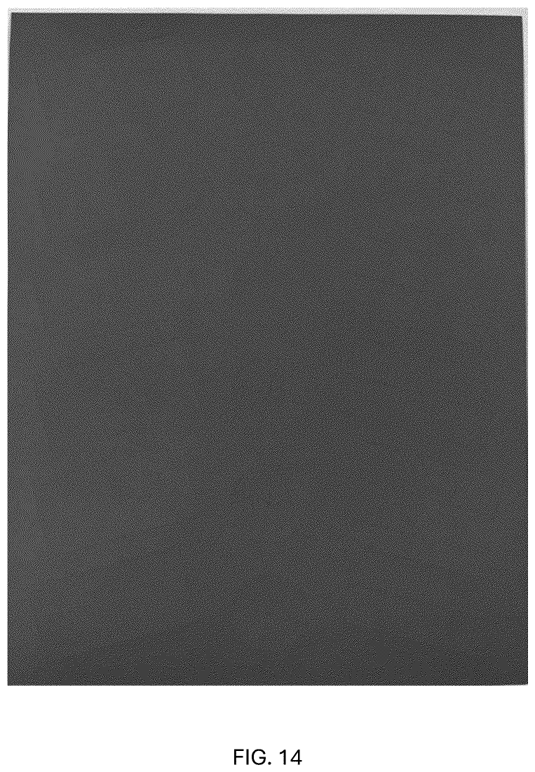

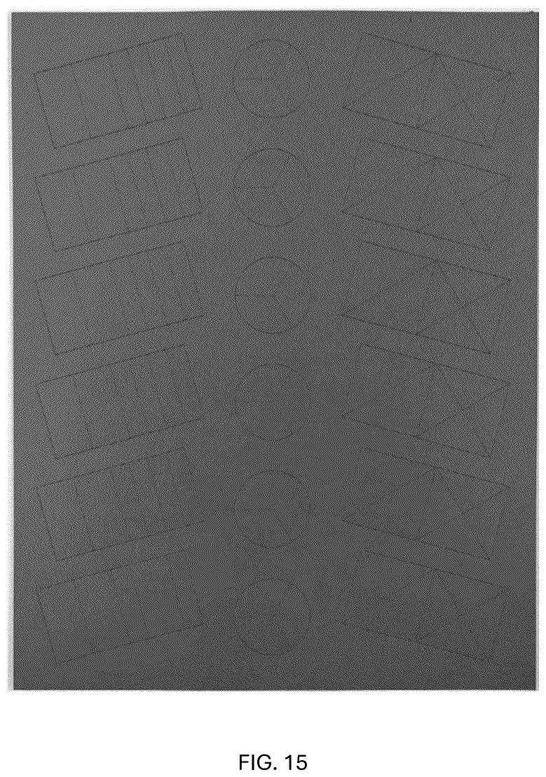

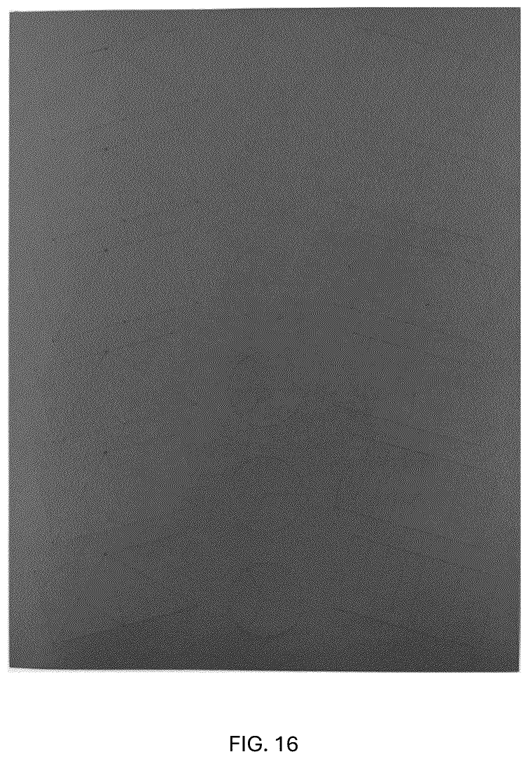

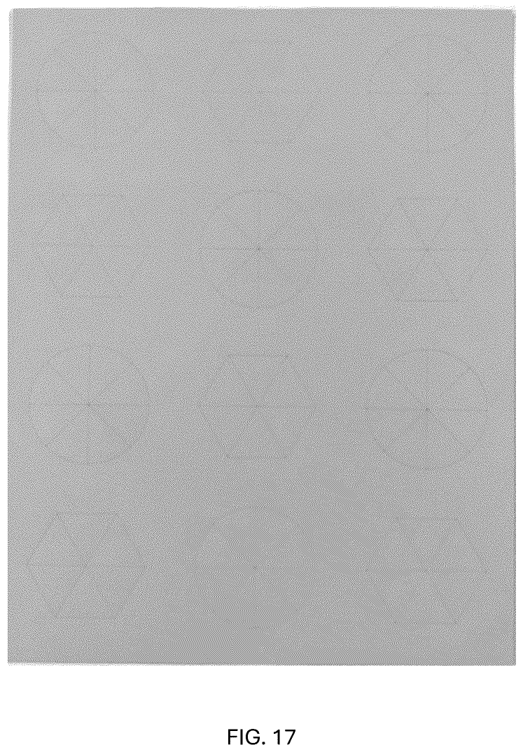

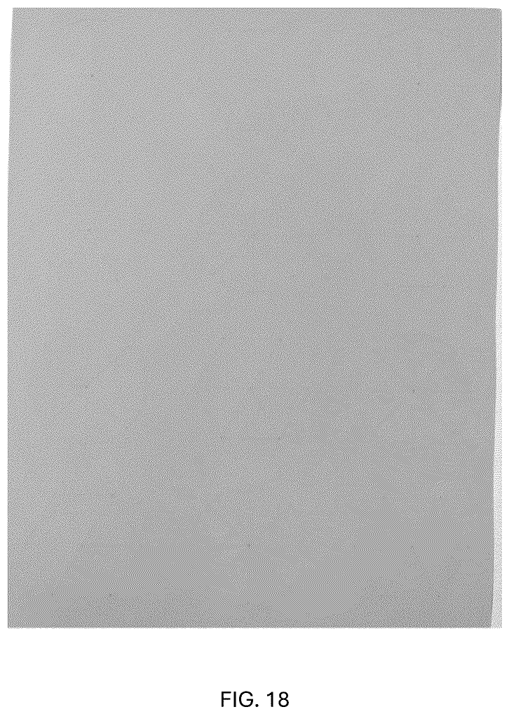

With reference now to FIGS. 13-22, in accordance with another aspect of the invention, a paper kit includes one or more sheets of pre-cut paper. Each of the pre-cut paper sheets may have one or more predetermined geometric or other shapes pre-cut therein. The sheets of paper may be any color, including black and/or white. In one form, they are bright, saturated, blank colored card stock. Preferably, the paper is of a suitable weight commonly used in the paper craft industry. Also preferably, the paper weight permits a consistent feel, finish and form, supports portability and consistency of manufacturing, and keeps bulkiness of the package to a minimum. In one preferred form, the paper is about 65 lb. to about 80 lb. or equivalent in weight, uncoated cover.

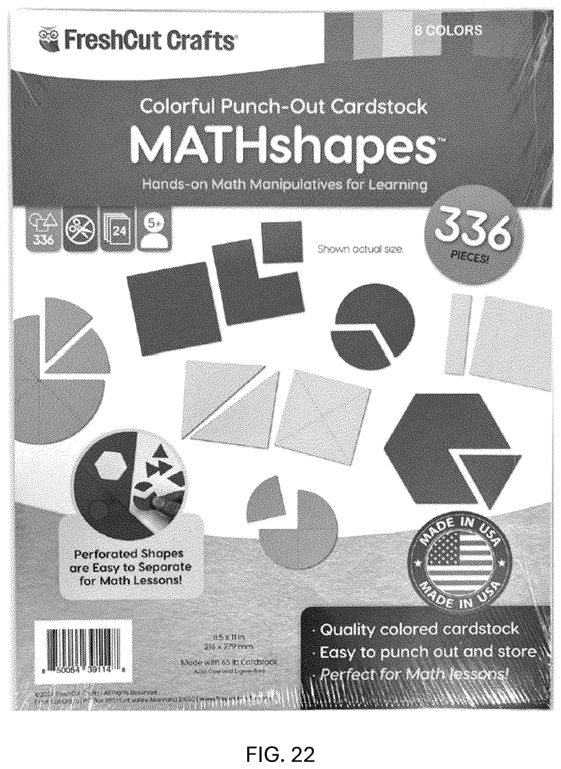

As shown in FIG. 22, the kit may include one or more of a variety of different colored sheets. Each of the sheets may have one or more predetermined shapes pre-cut therein. The shapes may be cut into the sheets by any known cutting technology, including but not limited to, laser cutting, metal plates and rotary die-cutting, automated knife cutting, and digital flatbed cutting.

The shapes themselves may preferably include one or more geometric shapes, including but not limited to, circles, semi-circles, ovals, triangles, squares, rectangles, parallelograms, rhombuses, trapezoids, kites, diamonds, pentagons, hexagons, heptagons, octagons, nonagons, and decagons. The shapes pre-cut into each paper sheet may be of all one size and shape and/or a variety of different sizes and/or shapes.

In accordance with another aspect, the pre-cut geometric shapes are held in place in the paper sheets with one or more small “tabs” of paper that form a connection between the shape and the sheet that holds it. The tabs are preferably small, and allow the shape to be manually removed (i.e. punched out) smoothly with barely a trace of the tabs remaining attached to the shapes. In one preferred form, the tabs are up to about 1.5 pt. in width. Thus, the pre-cut geometric shapes may advantageously be punched out and manipulated for instruction, exploration, and play.

In accordance with another aspect, the pre-cut geometric shapes may include one or more perforations that facilitate the deconstruction of a geometric shape into two or more predetermined portions. Thus, the pre-cut geometric shapes of the present invention may advantageously be used to tangibly demonstrate various mathematical concepts including but not limited to geometry, fractions, addition, subtraction, and negative space. Preferably, the one or more perforations are configured for easy-tear and deconstruction of a single geometric shape into two or more predetermined portions. The perforations may have any suitable configuration or shape including for example, horizontal lines, vertical lines, diagonal lines, curved lines, concentric circles, and/or smaller geometric shapes.

The pre-cut paper shapes of the present invention may advantageously be used in a variety of individual and/or group educational, exploration, and/or crafting environments, pre-cut paper projects, and for mathematical, creative, and/or artistic instruction and/or exploration.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A paper sheet comprising:
plurality of pre-cut, geometric shapes disposed therein;
a plurality of paper tabs securing each of the plurality of pre-cut geometric shapes to the paper sheet, wherein the paper tabs are configured to facilitate manual removal of the pre-cut geometric shapes from the paper sheet;
one or more perforations defined in the pre-cut geometric shapes, wherein the perforations are configured to divide a pre-cut geometric shape into two or more predetermined portions.

2. A kit comprising a plurality of the paper sheets of claim 1, wherein each of the plurality of paper sheets comprises a different arrangement of pre-cut, geometric shapes disposed therein.
